(19) United States
(12) Patent Application Publication
(10) Pub. No.: US 2012/0014227 A1
(43) Pub. Date: Jan. 19, 2012

(54) Stepping motor control circuit and analog electronic timepiece

(76) Inventors: Keishi Honmura, Chiba-shi (JP); Saburo Manaka, Chiba-shi (JP); Kenji Ogasawara, Chiba-shi (JP); Kazumi Sakumoto, Chiba-shi (JP); Hiroshi Shimizu, Chiba-shi (JP); Kosuke Yamamoto, Chiba-shi (JP); Shotaro Kamiyama, Chiba-shi (JP)

(21) Appl. No.: 13/135,767

(22) Filed: Jul. 14, 2011

(30) Foreign Application Priority Data
Jul. 16, 2010 (JP) 2010-161689
May 18, 2011 (JP) 2011-111527

(51) Int. Cl. G04C 3/14; H02P 8/38

(52) U.S. Cl. 368/80; 318/696

(57) ABSTRACT

A detection interval in which the rotation status of a stepping motor is divided into a first interval immediately after driving executed by a main driving pulse, a second interval later than the first interval, and a third interval later than the second interval. The driving is executed by a correction driving pulse and the main driving pulse is increased, when a control circuit drives the stepping motor in a driving way different from a driving way at the time of exceeding a predetermined voltage in a case where the voltage of a secondary battery is lowered to be equal to or less than the predetermined voltage and when a rotation detection circuit and a detection time comparison determination circuit detect an induced signal exceeding a first reference threshold voltage in the first interval and the second interval and do not detect the induced signal exceeding a second reference threshold voltage lower than the first reference threshold voltage in the third interval.

### BACKGROUND OF THE INVENTION

1. Field of the Invention

The present invention relates to a stepping motor control circuit and an analog electronic timepiece using the stepping motor control circuit.

2. Background Art

Hitherto, an electronic apparatus such as an analog electronic timepiece has utilized a two-pole PM (Permanent Magnet) type stepping motor that includes a stator having a rotor accommodation hole and a positioning portion determining the stop position of the rotor, a rotor disposed in the rotor accommodation hole, and a coil and that rotates the rotor by supplying an alternation signal to the coil and generating a magnetic flux in the stator and stops the rotor at the position corresponding to the positioning portion.

As a low-consumption driving method of the two-pole PM type stepping motor, a correction driving method of the stepping motor, which has a main driving pulse P1 consuming a small amount of energy at a normal time and a correction driving pulse P2 being used for driving the stepping motor at the time of load change and consuming a large amount of energy, has been put to practical use. The main driving pulse P1 is configured so as to decrease/increase the energy in accordance with rotation/non-rotation of the rotor and perform shift for driving the stepping motor using as little energy as possible (see JP-B-61-15385).

According to the correction driving method, (1) the main driving pulse P1 is output to one pole O1 of the coil and an induced voltage generated in the coil by the oscillation of the rotor immediately after the outputting of the main driving pulse P1 is detected. (2) When the induced voltage exceeds an arbitrarily set reference threshold voltage, the rotor is rotated, the main driving pulse P1 holding the energy is output to the other pole O2 of the driving coil, and this process is repeated by the given number of times as long as the rotor rotates. When the number of time reaches a given number (PCD), the main driving pulse P1, in which the energy is further reduced, is output to the other pole O2 and this process is repeated again. (3) When the induced voltage does not exceed the reference threshold voltage, the rotor is not rotated, the correction driving pulse P2 with the large amount of energy is immediately output to the same pole, and the rotor is forcibly rotated. At the subsequent driving time, the main driving pulse P1 with the energy larger by one rank than that of the main driving pulse P1 used for the non-rotation is output to the other pole and the processes (1) to (3) are repeated.

Further, according the invention disclosed in WO2005/119377, when the rotation of the stepping motor is detected, means for comparing and distinguishing a detection time and a reference time one another is provided as well as the detection of the induced signal. After the stepping motor is rotatably driven by a main driving pulse P11 and then the detection signal has a voltage less than a predetermined reference threshold voltage Vcomp, a correction driving pulse P2 is output and the subsequent main driving pulse P1 is changed into a main driving pulse P12 with an energy larger than that of the main driving pulse P11 (pulse increase) for driving. When the detection time in the rotating of the stepping motor by the main driving pulse P12 is earlier than the reference time, the consumption current is reduced by changing the main driving pulse P12 into the main driving pulse P11 (pulse decrease) and rotating the stepping motor by the main driving pulse P1 in accordance with the load of the driving time.

However, in an electronic timepiece using a secondary battery as a power source, power generation means such as a solar_power generation device is configured to charge the secondary battery. The secondary battery is charged by the power generation means such as a solar power generation device and the voltage is increased or decreased.

When the voltage of the secondary battery becomes less than a given voltage, the fact that the power-supply voltage is lowered to a usable voltage limit is announced (BLD) and transition to a sleep state where a hand movement stops is executed. For example, a BLD hand movement where timepiece hands are moved in a way different from the normal hand movement way is executed by the above announcement. In the BLD hand movement, for example, the driving corresponding to two seconds is executed every two seconds by a predetermined fixed pulse.

Since the power-supply voltage is low immediately before the sleep state, the driving is unstable. Therefore, since a so-called halfway stop state occurs where the rotor is unusually stopped at a halfway position different from the regular stop position of the rotor in some cases, there is a problem in that erroneous determination of rotation or non-rotation is made or there is a problem in that the hand movement is delayed.

### SUMMARY OF THE INVENTION

It is an aspect of the present application to prevent the halfway stop by accurately determining the rotation status of a stepping motor even when the voltage of a secondary battery used as a power source is lowered.

According to the application, there is provided a stepping motor control circuit including: a secondary battery serving as a power source; rotation detection means for detecting an induced signal generated by rotation of a rotor of a stepping motor and detecting a rotation status of the stepping motor depending on whether the induced signal exceeds a predetermined reference threshold voltage within a predetermined detection interval; and control means for controlling driving of the stepping motor by one of a plurality of main driving pulses with mutually different energies or a correction driving pulse having an energy greater than that of each main driving pulse in accordance with the detection result of the rotation detection means. The detection interval is divided into a first interval immediately after the stepping motor is driven by the main driving pulse, a second interval later than the first interval, and a third interval later than the second interval. In a case where a voltage of the secondary battery is lowered to be equal to or less than a predetermined voltage, the control means drives the stepping motor by the correction driving pulse when the control means drives the stepping motor by the main driving pulse and then the rotation detection means detects the induced signal exceeding a first reference threshold voltage in the first and second intervals and does not detect the induced signal exceeding a second reference threshold voltage lower than the first reference threshold voltage in the third interval.

According to the application, there is provided an analog electronic timepiece including: a stepping motor rotatably driving timepiece hands; and a stepping motor control circuit controlling the stepping motor. As this stepping motor control circuit, the stepping motor control circuit described above is used.

In the stepping motor control circuit according to the application, it is possible to prevent the halfway stop by accurately determining the rotation status of the stepping motor even when the voltage of the secondary battery used as the power source is lowered.

In the analog electronic timepiece according to the application, it is possible to prevent the halfway stop by accurately determining the rotation status of the stepping motor even when the voltage of the secondary battery used as the power source is lowered. Accordingly, the reliable hand movement driving can be executed.

### BRIEF DESCRIPTION OF THE DRAWINGS

FIG. 1 is a block diagram illustrating a stepping motor control circuit and an analog electronic timepiece according to an embodiment of the invention.

FIG. 2 is a diagram illustrating the configuration of a stepping motor used in the analog electronic timepiece according to the embodiment of the invention.

FIG. 3 is a diagram illustrating timings used to explain the operations of the stepping motor control circuit and the analog electronic timepiece according to the embodiment of the invention.

FIG. 4 is a flowchart illustrating the operations of the stepping motor control circuit and the analog electronic timepiece according to the embodiment of the invention.

FIG. 5 is a circuit diagram illustrating the details of the stepping motor control circuit and the analog electronic timepiece according to the embodiment of the invention.

FIG. 6 is a circuit diagram illustrating the details of the stepping motor control circuit and the analog electronic timepiece according to another embodiment of the invention.

### DETAILED DESCRIPTION OF THE INVENTION

Hereinafter, a stepping motor control circuit and an analog electronic timepiece using the stepping motor control circuit will be described according to an embodiment of the invention. The same reference numerals are given to the same constituent elements throughout the drawings.

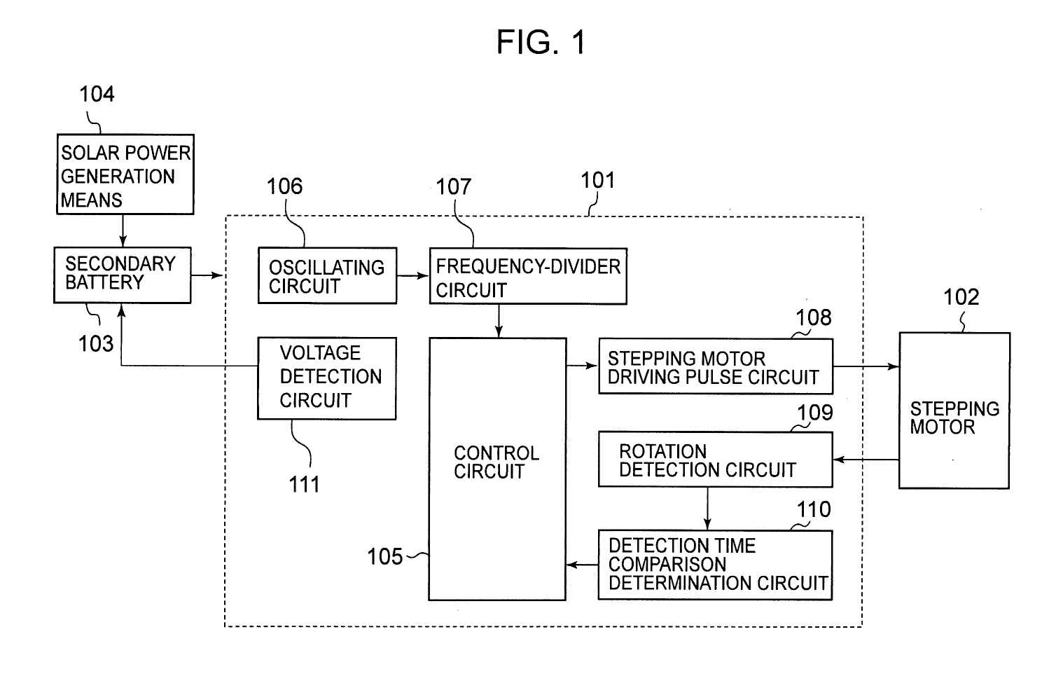

FIG. 1 is a block diagram illustrating the analog electronic timepiece using the stepping motor control circuit according to the embodiment of the invention. An example of the analog electronic timepieces is illustrated.

In FIG. 1, the analog electronic timepiece includes a stepping motor control circuit 101; a stepping motor 102 rotatably controlled by the stepping motor control circuit 101 and rotatably driving timepiece hands or a calendar mechanism (not shown); a secondary battery 103 serving as a power source supplying driving power to circuit elements such as the stepping motor control circuit 101 and the stepping motor 102; and solar power generation means 104 for charging the secondary battery 103.

The stepping motor control circuit 101 includes an oscillation circuit 106 generating a signal with a predetermined frequency; a frequency divider circuit 107 dividing the frequency of the signal generated by the oscillation circuit 106 and generating a timepiece signal serving as a reference for time measurement; a control circuit 105 controlling each electronic circuit element of the electronic timepiece or controlling a change in a driving pulse; and a stepping motor driving pulse circuit 108 selecting a driving pulse for motor rotation driving based on a control signal from the control circuit 105 and outputting the selected driving pulse to the stepping motor 102. The stepping motor control circuit 101 further includes a rotation detection circuit 109 detecting an induced signal VRs representing a rotation status of the stepping motor 102 during a predetermined detection period; a detection time comparison determination circuit 110 comparing times and intervals when the rotation detection circuit 109 detects the induced signal VRs exceeding a predetermined reference threshold voltage and determining at which interval the induced signal VRs is detected; and a voltage detection circuit 111 detecting the voltage of the secondary battery 103. As described below, the detection period in which the rotation statuses of the stepping motor 102 are detected is separated into three intervals.

The rotation detection circuit 109 has the same configuration as that of a rotation detection circuit disclosed in JP-A-61-15385. The rotation detection circuit 109 detects whether the induced signal VRs generated by free oscillation immediately after the driving of the stepping motor 102 exceeds a predetermined reference threshold voltage Vcomp during the predetermined detection period. Whenever detecting the induced signal VRs exceeding the reference threshold voltage Vcomp, the rotation detection circuit 109 notifies the detection time comparison determination circuit 110 of the induced signal VRs.

In this embodiment, the reference threshold voltage Vcomp includes two different types of reference threshold voltages Vcomp (a first reference threshold voltage Vcomp1 serving as a first predetermined voltage and a second reference threshold voltage Vcomp2 serving as a second predetermined voltage and being lower than the first reference voltage Vcomp1). The reference threshold voltage Vcomp is selected and used depending on a rotation status of the stepping motor 102.

Further, the oscillation circuit 106 and the frequency divider circuit 107 form signal generation means. The rotation detection circuit 109 and the detection time comparison determination circuit 110 form rotation detection means. The oscillation circuit 106, the frequency divider circuit 107, the control circuit 105, the stepping motor driving pulse circuit 108, and the voltage detection circuit 111 form control means. The solar power generation means 104 forms generation means for charging the secondary battery 103. The voltage detection circuit 111 forms voltage detection means.

The rotation detection means detects the induced signal VRs generated by the rotation of a rotor of the stepping motor 102 and can detect the rotation statuses of the stepping motor 102 depending on whether the induced signal VRs exceeds the predetermined threshold voltage during the predetermined detection period.

In some cases, when the voltage of the secondary battery is lowered to be equal to or less than a predetermined voltage and the stepping motor 102 is driven by a main driving pulse P1 in this state, the rotation detection means detects the induced signal VRs exceeding the first reference threshold voltage Vcomp1 in a first interval T1 and a second interval T2 of the detection period. In this case, when the induced signal VRs exceeding the second reference threshold voltage Vcomp2 lower than the first reference threshold voltage Vcomp1 cannot be detected in a third interval T3 of the detection period, the control means can be driven by a correction driving pulse P2.

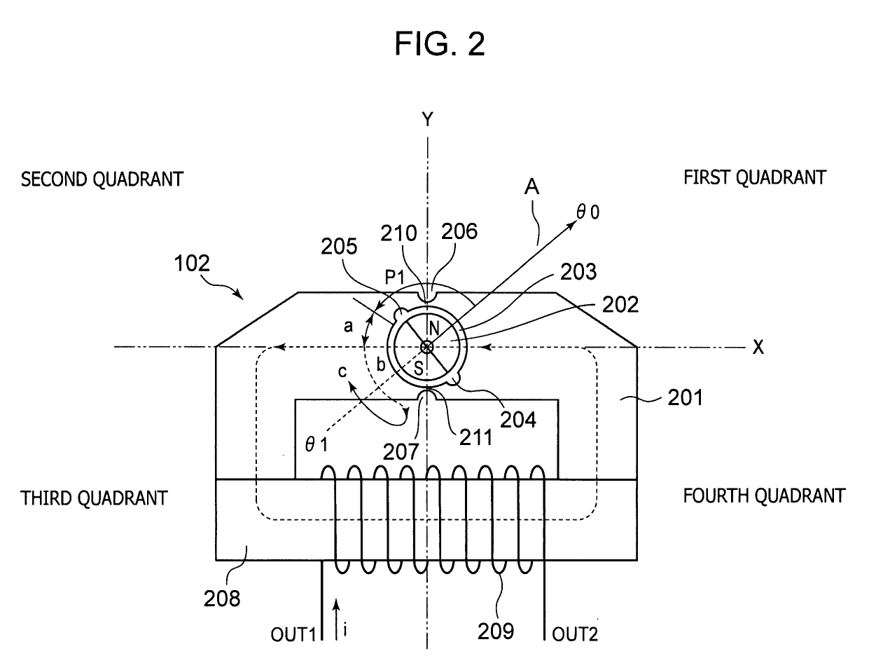

FIG. 2 is a diagram illustrating the configuration of the stepping motor 102 used according to the embodiment of the invention. In FIG. 2, an example of a two-pole PM-type stepping motor generally used in an analog electronic timepiece is shown.

In FIG. 2, the stepping motor 102 includes a stator 201 having a rotor accommodation through-hole 203, a rotor 202 rotatably disposed in the rotor accommodation through-hole 203, and a magnetic core 208 joined to the stator 201, and a coil 209 wound around the magnetic core 208. When the stepping motor 102 is used for an analog electronic timepiece, the stator 201 and the magnetic core 208 are fixed to a ground plate (not shown) by a screw or the like (not shown) to be joined to each other. The coil 209 includes a first terminal OUT1 and a second terminal OUT2.

The rotor 202 is disposed in two-pole (S pole and N pole) magnets. In the outer end portions of the stator 201 formed of a magnetic material, notches (outer notches) 206 and 207 are formed at the positions facing each other with the rotor accommodation through-hole 203 interposed therebetween. Saturable portions 210 and 211 are formed between the outer notches 206 and 207 and the rotor accommodation through-hole 203, respectively.

The saturable portions 210 and 211 are configured such that the saturable portions 210 and 211 are not saturated by the magnetic flux of the rotor 202 and are saturated and thus the magnetic resistance increases when the coil 209 is excited. The rotor accommodation through-hole 203 is formed with a circular hole shape in which a plurality of semilunar notches (inner notches) 204 and 205 (in this embodiment, two notches) are integrally formed with the through hole of the circular contour at the positions facing each other.

The notches 204 and 205 are configured as a positioning portion that determines the stop position of the rotor 202. When the coil 209 is not excited, as shown in FIG. 2, the rotor 202 is stably stopped at the position corresponding to the positioning portion, in other words, the position (angle θ0 position) at which a magnetic pole axis A of the rotor 202 is perpendicular to the line segment binding the notches 204 and 205 with each other. The XY coordinate space is divided into four quadrants (first to fourth quadrants) centered on the rotation axis (rotation center) of the rotor 202.

Here, when rectangular wave driving pulses are supplied from the stepping motor driving pulse circuit 108 to the terminals OUT1 and OUT2 of the coil 209 (for example, the first terminal OUT1 is set as a positive terminal and the second terminal OUT2 is set as a negative terminal) and a current i is flowed in an arrow direction of FIG. 2, the magnetic flux is generated in a dashed-line arrow direction in the stator 201. Thus, the saturable portions 210 and 211 are saturated and thus the magnetic resistance is increased. Thereafter, the rotor 202 is rotated at 180 degrees in the arrow direction of FIG. 2 by the interaction between the magnetic pole generated in the stator 201 and the magnetic pole generated in the rotor 202, so that the magnetic pole axis of the rotor 202 is stably stopped at an angle θ1. Here, by rotatably driving the stepping motor 102, the rotation direction (the counterclockwise direction in FIG. 2) in which a normal operation (a hand movement operation of the analog electronic timepiece in this embodiment) is executed is set as a positive direction and the opposite direction (clockwise direction) of the rotation direction is set as an opposite direction.

Next, when a reverse polarity rectangular wave driving pulse is supplied from the stepping motor driving pulse circuit 108 to the terminals OUT1 and OUT2 of the coil 209 (for example, the first terminal OUT1 is set as a negative terminal and the second terminal OUT2 is set as a positive terminal so as to become the reverse polarity to that of the above-described driving) and a current is flowed in the opposite direction of the arrow direction of FIG. 2, a magnetic flux is generated in an opposite dashed-line arrow direction in the stator 201. Thus, the saturable portions 210 and 211 are first saturated. Thereafter, the rotor 202 is rotated at 180 degrees in the above-described same direction by the interaction between the magnetic pole generated in the stator 201 and the magnetic pole generated in the rotor 202, so that the magnetic pole axis of the rotor 202 is stably stopped at the angle θ0.

In this way, it is configured that the operations are repeatedly executed to continuously rotate the rotor 202 at each 180 degrees in the arrow direction by supplying the signals (alternation signals) of different polarities to the coil 209. In this embodiment, as described below, a plurality of main driving pulses P10 to P1n with different energies one another and a correction driving pulse P2 are used as the driving pulses.

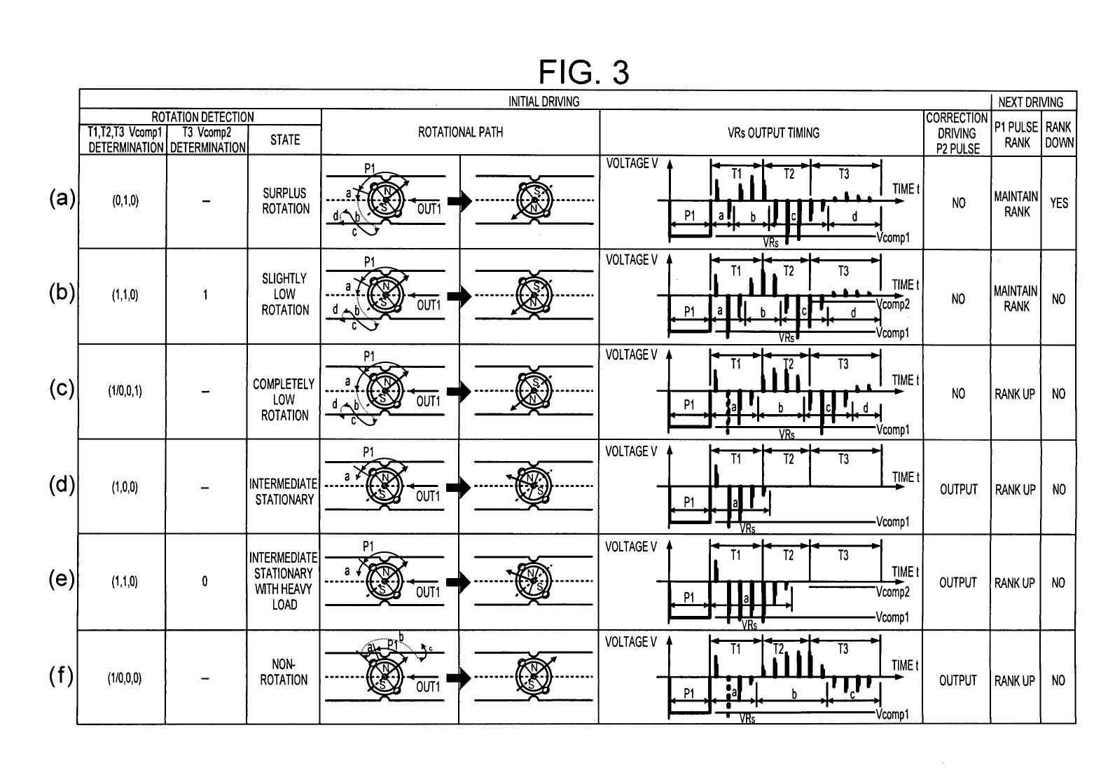

FIG. 3 is a diagram illustrating timings used when the stepping motor 102 is driven by the main driving pulse P1 according to the embodiment. In FIG. 3, shown are a detection pattern (a determination value used to determine whether the induced signal VRs of the intervals T1 to T3 exceeds the reference threshold voltage Vcomp), the rotation position of the rotor 202, the rank change of the main driving pulse P1, and a pulse control operation of executing driving by the correction driving pulse P2.

In FIG. 3, P1 denotes the main driving pulse P1 and an interval at which the rotor 202 is rotatably driven by the main driving pulse P1. In addition, a to d are regions indicating the rotation position of the rotor 202 by the free oscillation after the driving stop of the main driving pulse P1.

It is assumed that a predetermined time immediately after the driving executed by the main driving pulse P1 is a first interval T1, a predetermined time later than the first interval T1 is a second interval T2, and a predetermined time later than the second interval T2 is a third interval T3. Thus, the entire detection interval T started immediately after the driving executed by the main driving pulse P1 is divided into the plurality intervals (in this embodiment, three intervals T1 to T3). In this embodiment, there is provided no mask interval which is an interval at which the induced signal VRs is not detected.

When it is assumed that the XY coordinate space in which the main magnetic pole of the rotor 202 is located by the rotation about the rotor 202 is divided into first to fourth quadrants, the first interval T1 to the third interval T3 can be expressed as follows.

That is, in a normal load state, the first interval T1 is an interval at which the forward rotation status of the rotor 202 is determined in the third quadrant of the space centered on the rotor 202 and an interval at which the initial backward rotation status of the rotor 202 is determined. The second interval T2 is an interval at which the initial backward rotation status of the rotor 202 is determined in the third quadrant. The third interval T3 is an interval at which the rotation status after the initial backward rotation of the rotor 202 is determined in the third quadrant. Here, the normal load means a load driven at a normal time. In this embodiment, a load at the time of driving timepiece hands (an hour hand, a minute hand, and a second hand) for time display is set as the normal load.

The first reference threshold voltage Vcomp1 is a reference threshold voltage used to determine the voltage level of the induced signal VRs generated by the stepping motor 102. When the rotor 202 executes a constant fast operation as in a case where the stepping motor 102 is rotated, the induced signal VRs exceeds the first reference threshold voltage Vcomp1. When the rotor 202 does not execute the constant fast operation as in a case where the stepping motor 102 is not rotated, the first reference threshold voltage Vcomp1 is set so that the induced signal VRs does not exceed the first reference threshold voltage Vcomp1.

The second reference threshold voltage Vcomp2 is set to be lower than the first reference threshold voltage Vcomp1. The second reference threshold voltage Vcomp2 is a reference used to determine whether the induced voltage VRs exceeding a predetermined level is generated in the third interval T3 in order to determine whether the rotor 202 stops halfway when the induced voltage VRs of the first interval T1 and the second interval T2 exceeds the first reference threshold voltage Vcomp1. In this embodiment, the first reference threshold voltage Vcomp1 is set to, for example, 1.5 V and the second reference threshold voltage Vcomp2 is set to, for example, 0.3 V.

In the stepping motor control circuit according to this embodiment, in the normal load state, the induced signal VRs generated in the region b is detected in the first terminal T1. The induced signal VRs generated in the region c is detected in the first interval T1 and the second interval T2. The induced signal VRs generated in the region d is detected in the third interval T3.

In the first interval T1 to the third interval T3, when the induced signal VRs exceeds the reference threshold voltage Vcomp serving as a comparison reference, a determination value “1” is set. When the induced signal VRs does not exceed the reference threshold voltage Vcomp, a determination value “0” is set. When the determination value is either “1” or “0”, a determination value “1/0” is set.

In FIG. 3, for example, when a pattern (the determination value of the first interval T1, the determination value of the second interval T2, and the determination value of the third interval T3) is (0, 1, 0), the control circuit 105 determines that the rotation is continuous. Therefore, the control circuit 105 executes no driving by the correction driving pulse P2 and maintains the rank of the main driving pulse P1 without any change. When the pattern (0, 1, 0) continuously occurs the predetermined number of times, the control circuit 105 determines that the driving energy is enough and executes one rank-down (pulse decrease) on the main driving pulse P1 (see (a) of FIG. 3).

When the pattern is (1, 1, 0) and thus the induced signal VRs exceeding the second reference threshold voltage Vcomp2 is generated in the third interval T3 (the determination value by the second reference threshold voltage Vcomp2 is “1”), the control circuit 105 determines that the rotation continues a little. Therefore, the control circuit 105 does not execute the driving by the correction driving pulse P2 and executes pulse control so as to maintain the rank of the main driving pulse P1 without any change (see (b) of FIG. 3). When the induced signal VRs exceeding the second reference threshold voltage Vcomp2 is not generated in the third interval T3 (the determined value by the second reference threshold voltage Vcomp2 is “0”), the control circuit 105 determines that the rotation is in large load halfway stop state. Therefore, the control circuit 105 executes the driving by the correction driving pulse P2 and then executes pulse control so as to executes one rank-up (pulse increase) on the main driving pulse P1 (see (e) of FIG. 3).

When the pattern is (1/0, 0, 1), the control circuit 105 determines that the rotation does not continue at all. Therefore, the control circuit 105 does not execute the driving by the correction driving pulse P2 and executes one rank-up (pulse increase) on the main driving pulse P1 (see (c) of FIG. 3).

When the pattern is (1, 0, 0), the control circuit 105 determines that the rotor 202 stops at the halfway position. Therefore, the control circuit 105 executes the driving by the correction driving pulse P2 and executes one rank-up on the main driving pulse P1 (see (d) of FIG. 3).

When the pattern is (1/0, 0, 0), the control circuit 105 determines that the rotor 202 does not rotate. Therefore, the control circuit 105 executes the driving by the correction driving pulse P2 and then executes one rank-up on the main driving pulse P1 (see (f) of FIG. 3).

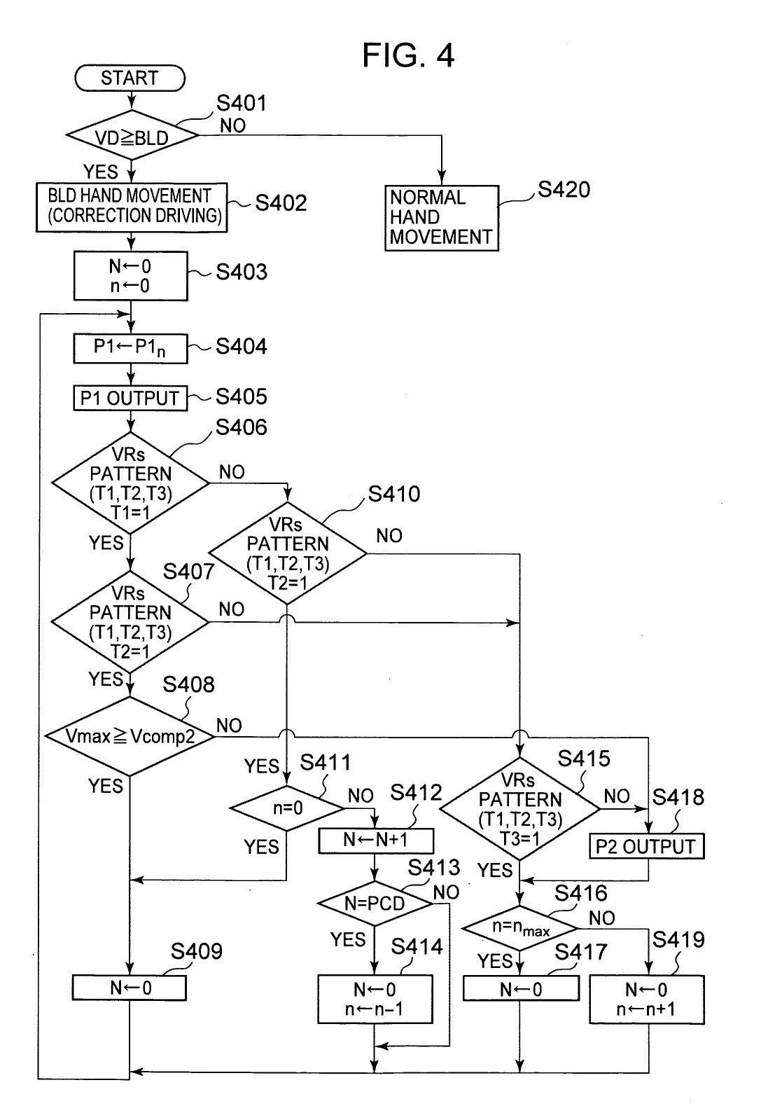

FIG. 4 is a flowchart illustrating the operations of the stepping motor control circuit and the analog electronic timepiece according to the embodiment of the invention. In the flowchart, the operation of the control circuit 105 is mainly shown.

Hereinafter, the operations of the stepping motor control circuit and the analog electronic timepiece will be described in detail with reference to FIGS. 1 to 4 according to the embodiment of the invention.

In FIG. 1, the oscillation circuit 106 generates a reference clock signal with a predetermine frequency. The frequency divider circuit 107 divides the frequency of the signal generated by the oscillation circuit 106, generates a clock signal serving as a reference of the time measurement, and outputs the clock signal to the control circuit 105.

When the voltage VD of the secondary battery 103 detected by the voltage detection circuit 111 is not equal to or less than a predetermined voltage BLD (step S401), the control circuit 105 drives the stepping motor driving pulse circuit 108 so that the stepping motor 102 executes the normal hand movement of the timepiece hands (step S420). In the normal hand movement of the process of step S420, the control circuit 105 perform control so that the stepping motor driving pulse circuit 108 rotatably drive the stepping motor 102 by the predetermined main driving pulse P1 (fixed driving pulse Pk) with a given power. Thus, the stepping motor 102 drives the timepiece hands to display the current time by the timepiece hands.

When the voltage VD of the secondary battery 103 is equal to or less than the predetermined voltage BLD in step S401, the control circuit 105 executes the BLD hand movement to control the driving of the stepping motor 102 in the driving way different from the driving way at the time when the voltage of the secondary battery 103 exceeds the predetermined voltage BLD (step S402). The driving of the BLD hand movement is a correction driving method of driving the stepping motor by the correction driving pulse P2 under the given condition. The predetermined voltage BLD is a usable voltage limit of the power of the secondary battery 103.

In the BLD hand movement, the control circuit 105 counts the time signal and executes the time measurement operation. First, the control circuit 105 sets the rank n and the repetition number N of a main driving pulse P1n to 0 (step S403 of FIG. 4) and outputs a control signal so as to execute the rotation driving of the stepping motor 102 by a main driving pulse P10 with the minimum pulse width (step S404 and step S405).

The stepping motor driving pulse circuit 108 responds to the control signal from the control circuit 105 and executes the rotation driving of the stepping motor 102 by the main driving pulse P10. The stepping motor 102 is subjected to the rotation driving by the main driving pulse P10 to execute rotation driving of the timepiece hands (not shown). In this way, when the stepping motor 102 normally rotates, the hand movement of the timepiece hands is executed.

The rotation detection circuit 109 outputs a detection signal to the detection time comparison determination circuit 110 whenever the rotation detection circuit 109 detects the induced signal VRs of the stepping motor 102 exceeding the first reference threshold voltage Vcomp1. The detection time comparison determination circuit 110 determines the intervals T1 to T3, in which the induced signal VRs exceeding the first reference threshold voltage Vcomp1 is detected, based on the detection signal from the rotation detection circuit 109 and notifies the control circuit 105 of the determination value “1” or “0” in each of the intervals T1 to T3.

The control circuit 105 determines the pattern (the determination value in the first interval T1, the determination value in the second interval T2, and the determination value in the third interval T3) (VRs pattern) indicating the rotation status based on the determination values of the detection time comparison determination circuit 110.

When the determination value is “1” in the first interval T1 and the second interval T2 of the VRs pattern of the result obtained by driving the stepping motor by the main driving pulse P10, that is, the VRs pattern is (1, 1, 1/0) (step S406 and step S407) and when the maximum value Vmax of the induced signal Vrs exceeds the second reference threshold voltage Vcomp2 in the third interval T3 (step S408), the control circuit 105 determines that the stepping step is not in the halfway stop state and the rotation continues a little. Therefore, the control circuit 105 maintains the rank of the main driving pulse P1 without any change, resets the repetition number N to 0, and then returns the process to the process of step S404 (step S409).

When the control circuit 105 determines that the induced signal VRs does not exceed the second reference threshold voltage Vcomp2 in the third interval T3 (the large load halfway stop state (see (e) of FIG. 3) of the pattern (1, 1, 0)) in the process of step S408, the control circuit 105 controls the stepping motor driving pulse circuit 108 so as to drive the stepping motor 102 by the correction driving pulse P2 (step S418). The stepping motor driving pulse circuit 108 rotatably drives the stepping motor 102 by the correction driving pulse P2 under the control of the control circuit 105.

Next, when the rank n of the main driving pulse P1 is the maximum rank nmax, the control circuit 105 resets the repetition number N to 0 and then returns the process to step S404 (step S416 and step S417). On the other hand, when the rank n of the main driving pulse P1 is not the maximum rank nmax, the control circuit 105 resets the repetition number N to 0, increases the rank n of the main driving pulse P1 by one rank, and then returns the process to step S404 (step S416 and step S419).

When the control circuit 105 determines that the induced signal VRs does not exceed the first reference threshold voltage Vcomp1 in the second interval T2 in the process of step S407 (when the determination value is (1, 0) of the intervals T1 and T2) and determines that the determination value of the third interval T3 is “1”, that is, the VRs pattern is (1, 0, 1), the process proceeds to step S416 and the subsequent pulse increase control is executed (step S415) (see (c) of FIG. 3).

When the control circuit 105 determines that the determination value of the third interval T3 is “0” in the process of step S415, that is, the VRs pattern is (1, 0, 0), the process proceeds to the process of step S418, the subsequent driving is executed by the correction driving pulse P2, and the pulse increase control is executed (see (d) of FIG. 3).

When the determination value of the first interval T1 is “0” in the process of step S406, the determination value of the second interval T2 is “1” (step S410), and the rank n of the main driving pulse P1 is the minimum value 0, the control circuit 105 allows the process to proceed to step S409 (step S411). When the rank n of the main driving pulse P1 is not the minimum value 0, the control circuit 105 increases the repetition number N by one (step S412).

When the repetition number N reaches the predetermined number (PCD) in the process of step S412, the control circuit 105 resets the repetition number N to 0 and decreases the rank n of the main driving pulse P1 by one rank. Then, the process returns to step S404. When the repetition number N does not reach the predetermined number, the process immediately returns to step S404 (step S413 and step S414).

When the determination value of the second interval T2 is “0” in the process of step S410, the control circuit 105 allows the process to step S415 to execute the above-described process.

The control circuit 105 announces (BLD) the fact that the voltage of the secondary battery 103 is lowered to the usable voltage limit by repeating the processes from step S402 to 5419 so as to control the rotation driving of the stepping motor 102 in the way different from that of the driving (step S420) at the time when the voltage of the secondary battery 103 exceeds the predetermined voltage BLD, and then controls transition to the sleep state where the hand movement is stopped.

For example, when the process of step S420 is an operation of rotatably driving the stepping motor 102 in a period of one second, that is, a normal hand movement operation of moving the timepiece hands in a period of one second, the control circuit 105 controls the stepping motor driving pulse circuit 108, for example, so that the stepping motor 102 executes the driving corresponding to two seconds every two seconds as the announcement operation of moving the timepiece hands in a way different from the way of the normal hand movement. Thereafter, the control circuit 105 executes the control so as to transit to the sleep state, when the voltage of the secondary battery 103 is further lowered to a voltage equal to or less than the predetermined voltage. In the sleep state, the driving of the stepping motor 102 is completely stopped and the hand movement of the timepiece hands or the like is also stopped.

The control circuit 105 resumes the rotation driving of the stepping motor 102, when the secondary battery 103 is charged by the solar power generation means 104 and the voltage of the secondary battery becomes equal to or greater than the predetermined voltage exceeding the predetermined voltage BLD after the transition to the sleep state.

In this way, in the stepping motor control circuit and the analog electronic timepiece according to this embodiment, the generation time of the induced signal VRs is divided into the plurality of intervals (in this embodiment, the first interval T1, the second interval T2, and the third interval T3). The induced signal VRs of each interval is compared to the first reference threshold voltage Vcomp1. The rotation status of the rotor 202 is determined according to the pattern of the determination values to control the driving pulses. For example, when the pattern is (1/0, 1, 1/0) and (1/0, 0, 1), the rotation status is determined to the rotation state. When the pattern is (1/0, 0, 0), the rotation status is determined to the non-rotation state.

As described above, the two-pole PM type stepping motor comes to be in the rotation state or the non-rotation state in accordance with the driving pulses. However, when a force acting on the rotor such as a calendar operation or a power-supply voltage change is considerably changed, the halfway stop state occurs where the rotor is unusually stopped at a halfway position different from the stop position of the rotor 202. In this state, the pattern is normally (1, 0, 0) in the VRs pattern determination and is the VRs pattern like the non-rotation state. However, since the pattern is (1, 1, 0) depending on the load state in some cases, the pattern is the VRs pattern like the rotation state. That is, even when the stepping motor cannot normally be rotated, an erroneous determination that the stepping motor is rotated is made in some cases.

In this embodiment, however, there is provided the detection time comparison determination circuit 110 that stores the voltage values and the output times of the induced signal VRs generated by the oscillation of the rotor 202 as the VRs pattern and compares the voltage values and the output times to each other.

Further, when the voltage of the secondary battery 103 is lowered to be equal to or less than the predetermined voltage BLD, the second reference threshold voltage Vcomp2 is provided only in the third interval T3 of the VRs pattern apart from the non-rotation state in order to determine the halfway stop state unusually occurring when the change in the load of the rotor is considerable. Therefore, the energy of the driving pulse is configured to be controlled in accordance with the specific VRs pattern and the voltage value of the induced signal VRs of the third interval T3.

That is, in the case of the halfway stop, the second reference threshold voltage Vcomp2 having the level lower than that of the first reference threshold voltage Vcomp1 is set only in the third interval T3 in that the rotor 202 is not oscillated at all in the third interval T3. In addition, only when the determination values of both the first interval T1 and the second interval T2 are “1”, the induced signal VRs detected in the third interval T3 is determined with the second reference threshold voltage Vcomp2. When the determination result satisfies the relationship of “the induced signal VRs of the third interval T3≧the second reference threshold voltage Vcomp2”, the driving is not executed by the correction driving pulse P2. When the determination result satisfies the relationship of “the induced signal VRs of the third interval T3<the second reference threshold voltage Vcomp2”, the driving is executes by the correction driving pulse P2.

Accordingly, the stepping motor control circuit according to this embodiment can accurately determine the rotation status of the stepping motor 102 and can reliably execute the stable correction driving, even when the voltage of the secondary voltage 103 is equal to or less than the predetermined voltage BLD.

Thus, even when the voltage of the secondary battery 103 used as the power source is lowered, it is possible to prevent the halfway stop of the analog electronic timepiece using the secondary battery 103 as the power source. Accordingly, since delay of the erroneous hand movement does not occur even after restoration of the sleep state, it is possible to reliably realize the stable driving.

In the analog electronic timepiece according to this embodiment, even when the voltage of the secondary battery 103 is equal to or less than the predetermined voltage BLD, it is possible to accurately determine the rotation status of the stepping motor 102, prevent the halfway stop, and reliably execute the stable correction driving. Accordingly, the accurate hand movement can be executed.

Without the change in the integrated circuit (IC) of the stepping motor control circuit 101 and the motor specification, it is possible to obtain the advantages corresponding to various movements such as small load straight system, a function system with a calendar load, and mounting of the battery in which voltage is varied.

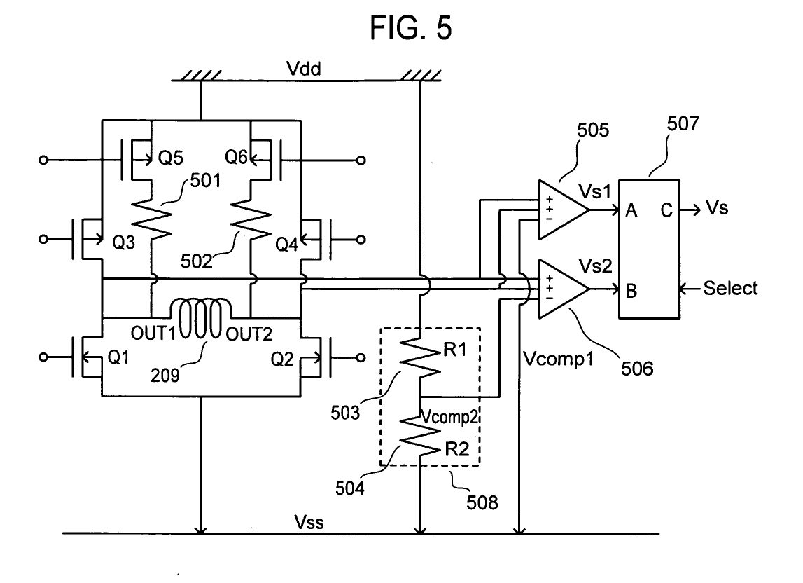

FIG. 5 is a circuit diagram illustrating the details of the stepping motor control circuit and the analog electronic timepiece according to the embodiment of the invention and a circuit diagram illustrating the partial details of the stepping motor driving pulse circuit 108 and the rotation detection circuit 109 shown in FIG. 1. The same reference numerals are given to the same constituent elements in FIGS. 1 to 4.

In FIG. 5, transistors Q1 and Q2 are constituent elements of the stepping motor driving pulse circuit 108. Transistors Q5 and Q6 and detection resistors 501 and 502 are constituent elements of the rotation detection circuit 109. Transistors Q3 and Q4 are constituent elements common to both the stepping motor driving pulse circuit 108 and the rotation detection circuit 109. The detection resistors 501 and 502 are elements having the same resistance value and form the detection element. The coil 209 is a driving coil of the stepping motor 102. Further, the circuit itself including the transistors Q1 to Q6 and the detection resistors 501 and 502 is a known circuit.

Resistors 503 and 504 connected to each other in series between a power-supply voltage Vss and a ground voltage Vdd are resistors that generate the reference threshold voltage Vcomp. The resistors 503 and 504 form a reference threshold voltage generation circuit 508 that generates the reference threshold voltage Vcomp. The second reference threshold voltage Vcomp2 is output from the connection point between the resistors 503 and 504, and the first threshold voltage Vcomp1 higher than the second reference threshold voltage Vcomp2 is output from the side of the power-supply voltage Vss of the resistor 504.

Thus, the two reference threshold voltages Vcomp1 and Vcomp2 are output simultaneously from the reference threshold voltage generation circuit 508 that includes the resistors 503 and 504.

In the example of FIG. 5, the first reference threshold voltage Vcomp1 is the same as the power-supply voltage Vss. The second reference threshold voltage Vcomp2 is the same as Vss·R1/(R1+R2). Here, R1 and R2 are the resistance values of the resistors 503 and 504, respectively.

The induced signal VRs and the first reference threshold voltage Vcomp1 detected by the detection resistors 501 and 502 are input to a first comparator 505. The first comparator 505 compares the induced signal VRs indicating the rotation status of the stepping motor 102 to the first reference threshold voltage Vcomp1 and outputs a detection signal Vs1 indicating whether the induced signal VRs exceeds the first reference threshold voltage Vcomp1.

The induced signal VRs and the second reference threshold voltage Vcomp2 detected by the detection resistors 501 and 502 are input to a second comparator 506. The second comparator 506 compares the induced signal VRs indicating the rotation status of the stepping motor 102 to the second reference threshold voltage Vcomp2 and outputs a detection signal Vs2 indicating whether the induced signal VRs exceeds the second reference threshold voltage Vcomp2.

The detection signals Vs1 and Vs2 respectively output from the first comparator 505 and the second comparator 506 are input to a selection circuit 507. The selection circuit 507 responds to a selection control signal select from the control circuit 105 and selectively outputs, as the detection signal Vs, the detection signal Vs1 or Vs2, which is output from the first comparator 505 or the second comparator 506, to the detection time comparison determination circuit 110. Here, when the selection control signal select is in a low level (0), the selection circuit 507 outputs the detection signal Vs1 from the first comparator 505 as the detection signal Vs. When the selection control signal select is in a high level (1), the selection circuit 507 outputs the detection signal Vs2 from the second comparator 506 as the detection signal Vs.

Further, the resistors 503 and 504, the comparators 505 and 506, and the selection circuit 507 are constituent elements of the rotation detection circuit 109.

When the stepping motor 102 is rotatably driven, a driving current is supplied to the coil 209 of the stepping motor 102 by driving the transistors Q2 and Q3 in an ON state by the main driving pulse P1. Thus, the rotor 202 of the stepping motor 102 is rotatably driven at 180 degrees in the forward direction.

The rotation detection circuit 109 detects the induced signal VRs generated in the detection resistor 502 by switching the transistor Q4 in the state where the control circuit 105 turns on the transistors Q3 and Q6 in the detection interval T immediately after the driving by the main driving pulse P1.

The first comparator 505 compares the induced signal VRs to the first reference threshold voltage Vcomp1 and outputs, to the selection circuit 507, the detection signal Vs1 indicating whether the induced signal VRs exceeds the first reference threshold voltage Vcomp1. Simultaneously, the second comparator 506 compares the induced signal VRs to the second reference threshold voltage Vcomp2 and outputs, to the selection circuit 507, the detection signal Vs2 indicating whether the induced signal VRs exceeds the second reference threshold voltage Vcomp2. Further, the second comparator 506 may execute control so that an operation is executed only in the third interval T3 of the detection interval T.

The control circuit 105 supplies the selection control signal select with the low level to the selection circuit 507 so that the selection circuit 507 outputs the detection signal Vs1 of the first comparator 505 as the detection signal Vs in the first interval T1 and the second interval T2.

The control circuit 105 supplies the selection control signal select with the low level or the high level to the selection circuit 507 so that the selection circuit 507 selects and outputs one of the detection signals Vs1 and the Vs2 of the first comparator 505 and the second comparator 506 in the continuous third interval T3 depending on whether the induced signal exceeding the reference threshold voltage Vcomp1 is detected in both the first interval T1 and the second interval T2 (whether the pattern is (1, 1) in the first interval T1 and the second interval T2).

That is, when the induced signal VRs exceeding the first reference threshold voltage Vcomp1 is detected in both the first interval T1 and the second interval T2, the control circuit 105 determines that there is a possibility that the halfway stop may occur and outputs the selection control signal select with the high level to the selection circuit 507. The selection circuit 507 responds to the selection control signal select with the high level and outputs the detection signal Vs2 of the second comparator 506 as the detection signal Vs.

On the other hand, when the induced signal VRs exceeding the first reference threshold voltage Vcomp1 is not detected in at least one of the first interval T1 and the second interval T2, the control circuit 105 outputs the selection control signal select with the low level to the selection circuit 507 even in the third interval T3. The selection circuit 507 responds to the selection control signal select with the low level even in the third interval T3 and outputs the detection signal Vs1 of the first comparator 505 as the detection signal Vs.

In this way, the selection circuit 507 responds to the selection control signal select with the low level in the first interval T1 and the second interval T2 and outputs the detection signal Vs1 of the first comparator 505 as the detection signal Vs to the detection time comparison determination circuit 110. The selection circuit 507 responds to the selection control signal select with the low level in the third interval T3 and outputs the detection signal Vs1 of the first comparator 505 as the detection signal Vs to the detection time comparison determination circuit 110. In addition, the selection circuit 507 responds to the selection control signal select with the high level and outputs the detection signal Vs2 of the second comparator 506 as the detection signal Vs to the detection time comparison determination circuit 110.

The detection time comparison determination circuit 110 determines whether the induced signal VRs exceeding the first reference threshold voltage Vcomp1 is detected in the first interval T1 and the second interval T2. The detection time comparison determination circuit 110 sequentially outputs, to the control circuit 105, the determination values (when the induced signal VRs exceeds the first reference threshold voltage Vcomp1, the determination value is “1”, whereas when the induced signal VRs does not exceed the first reference threshold voltage Vcomp1, the determination value is “0”) of the first interval T1 and the second interval T2. Further, based on the detection signal from the selection circuit 507 in the third interval T3, the detection time comparison determination circuit 110 sequentially outputs, to the control circuit 105, the determination value indicating whether the induced signal VRs exceeding the first reference threshold voltage Vcomp1 is detected or the determination value indicating whether the induced signal VRs exceeding the second reference threshold voltage Vcomp2 is detected.

The control circuit 105 executes the above-described pulse control operation based on the pattern of the determination values determined by the detection time comparison determination circuit 110.

In the subsequent cycle in which the stepping motor 102 is rotatably driven, the driving current is supplied to the coil 209 of the stepping motor 102 by driving the transistors Q1 and Q4 in the ON state by the main driving pulse P1. Thus, the rotor 202 of the stepping motor 102 is rotatably driven at 180 degrees in the forward direction. In this case, the rotation status or whether there is a possibility that the halfway stop occurs is determined using the induced signal VRs generated in the detection resistor 501, so that the pulse control is executed.

By repeating the above-described operations, it is possible to prevent the halfway stop by accurately determining the rotation status of the stepping motor 102.

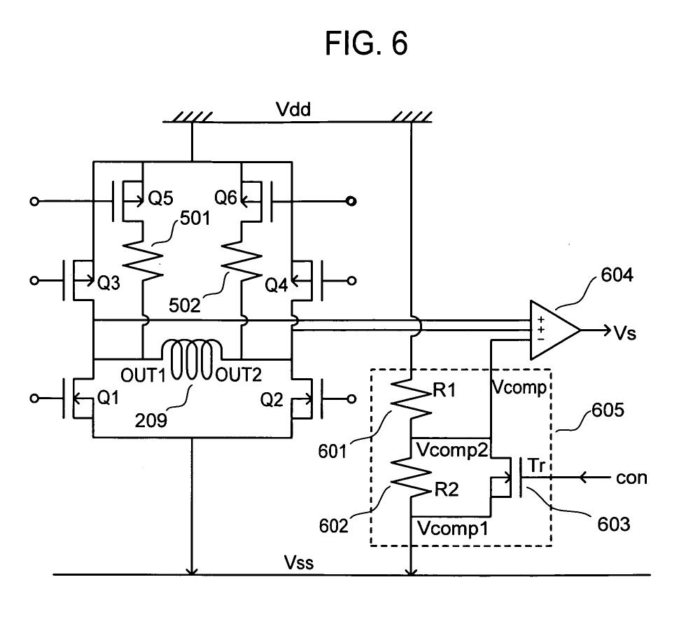

FIG. 6 is a circuit diagram illustrating the details of the stepping motor control circuit and the analog electronic timepiece according to the embodiment of the invention and a circuit diagram illustrating the partial details of the stepping motor driving pulse circuit 108 and the rotation detection circuit 109 shown in FIG. 1. The same reference numerals are given to the same constituent elements in FIGS. 1 to 5. The overall configuration is the same at that shown in FIG. 1.

In the embodiment of FIG. 5, the first reference threshold voltage Vcomp1 and the second reference threshold voltage Vcomp2 are simultaneously generated in parallel. However, in another embodiment, the first reference threshold voltage Vcomp1 and the second reference threshold voltage Vcomp2 are not simultaneously generated, but one thereof is alternately generated.

In FIG. 6, resistors 601 and 602 connected to each other in series between a power-supply voltage Vss and a ground voltage Vdd are resistors that generate the reference threshold voltage Vcomp. The second reference threshold voltage Vcomp2 is generated from the connection point between the resistors 601 and 602, and the first threshold voltage Vcomp1 higher than the second reference threshold voltage Vcomp2 is generated from the side of the power-supply voltage Vss of the resistor 602.

A transistor 603 is connected in parallel to the resistor 602. The transistor 603 responds to a reference threshold voltage selection signal con from the control circuit 105 and is controlled to an ON state or an OFF state. When the reference threshold voltage selection signal con is in a high level, the transistor 603 comes to be in the ON state and the first reference threshold voltage Vcomp1 is input to a comparator 604. When the reference threshold voltage selection signal con is a low level, the transistor 603 comes to be in the OFF state and the second reference threshold voltage Vcomp2 is input to the comparator 604.

Thus, the two reference threshold voltages Vcomp1 and Vcomp2 are output alternately from a reference threshold voltage generation circuit 605 that includes the resistors 601 and 602 and the transistor 603.

In the example of FIG. 6, the first reference threshold voltage Vcomp1 is the same as the power-supply voltage Vss. The second reference threshold voltage Vcomp2 is the same as Vss·R1/(R1+R2). Here, R1 and R2 are the resistance values of the resistors 601 and 602, respectively.

The induced signal VRs and the first reference threshold voltage Vcomp1 or the second reference threshold voltage Vcomp2 detected by the detection resistors 501 and 502 are input to the comparator 604. The comparator 604 compares the induced signal VRs indicating the rotation status of the stepping motor 102 to the first reference threshold voltage Vcomp1 or the second reference threshold voltage Vcomp2 and outputs a detection signal Vs indicating whether the induced signal VRs exceeds the first reference threshold voltage Vcomp1 or the second reference threshold voltage Vcomp2. The detection signal Vs output from the comparator 604 is input to the detection time comparison determination circuit 110.

The resistors 601 and 602, the transistor 603, and the comparator 604 are constituent elements of the rotation detection circuit 109.

When the stepping motor 102 is rotatably driven, a driving current is supplied to the coil 209 of the stepping motor 102 by driving the transistors Q2 and Q3 in an ON state by the main driving pulse P1. Thus, the rotor 202 of the stepping motor 102 is rotatably driven at 180 degrees in the forward direction.

The rotation detection circuit 109 detects the induced signal VRs generated in the detection resistor 502 by switching the transistor Q4 in the state where the control circuit 105 turns on the transistors Q3 and Q6 in the detection interval T immediately after the driving by the main driving pulse P1.

The comparator 604 compares the induced signal VRs to the input reference threshold voltage Vcomp and outputs, to the detection time comparison determination circuit 110, the detection signal Vs indicating whether the induced signal VRs exceeds the reference threshold voltage Vcomp.

The control circuit 105 supplies the reference threshold voltage selection signal con with the high level to the transistor 603 in the first interval T1 and the second interval T2 of the detection interval T so that the first reference threshold voltage Vcomp1 is input to the comparator 604.

The control circuit 105 supplies the reference threshold voltage selection signal con with the low level or the high level to the transistor 603 so that the reference threshold voltage generation circuit 605 selects and outputs one of the first reference threshold voltage Vcomp1 and the second reference threshold voltage Vcomp2 in the continuous third interval T3 depending on whether the induced signal exceeding the reference threshold voltage Vcomp1 is detected in both the first interval T1 and the second interval T2 (whether the pattern is (1, 1) in the first interval T1 and the second interval T2).

That is, when the induced signal VRs exceeding the first reference threshold voltage Vcomp1 is detected in both the first interval T1 and the second interval T2, the control circuit 105 determines that there is a possibility that the halfway stop may occur and outputs the reference threshold voltage selection signal con with the low level to the transistor 603. The transistor 603 responds to the reference threshold voltage selection signal con with the low level and is turned on, and the second reference threshold voltage Vcomp2 is input to the comparator 604.

On the other hand, when the induced signal VRs exceeding the first reference threshold voltage Vcomp1 is not detected in one of the first interval T1 and the second interval T2, the control circuit 105 outputs the reference threshold voltage selection signal con with the high level to the transistor 603. The transistor 603 responds to the reference threshold voltage selection signal con with the high level and is turned on, and the first reference threshold voltage Vcomp1 is input to the comparator 604.

In this way, the comparator 604 compares the induced signal VRs to the first reference threshold voltage Vcomp1 in the first interval T1 and the second interval T2 and outputs the fact that the induced signal exceeding the first reference threshold voltage Vcomp1 is detected or not. Further, the comparator 604 compares the reference threshold voltage Vcomp, which is selected depending on the detection state of the induced signal VRs in the first interval T1 and the second interval T2, to the induced signal VRs in the third interval T3 and outputs the fact that the induced signal VRs exceeding the reference threshold voltage Vcomp is detected or not.

The detection time comparison determination circuit 110 determines whether the induced signal VRs exceeding the first reference threshold voltage Vcomp1 is detected in the first interval T1 and the second interval T2. The detection time comparison determination circuit 110 sequentially outputs, to the control circuit 105, the determination values (when the induced signal VRs exceeds the first reference threshold voltage Vcomp1, the determination value is “1”, whereas when the induced signal VRs does not exceed the first reference threshold voltage Vcomp1, the determination value is “0”) of the first interval T1 and the second interval T2. Further, the detection time comparison determination circuit 110 sequentially outputs, to the control circuit 105, the determination values indicating whether the induced signal VRs exceeding the reference threshold voltage Vcomp selected in accordance with the detection states of the first interval T1 and the second interval T2 is detected in the third interval T3.

The control circuit 105 executes the above-described pulse control operation based on the pattern of the determination values determined by the detection time comparison determination circuit 110.

In the subsequent cycle in which the stepping motor 102 is rotatably driven, the driving current is supplied to the coil 209 of the stepping motor 102 by driving the transistors Q1 and Q4 in the ON state by the main driving pulse P1. Thus, the rotor 202 of the stepping motor 102 is rotatably driven at 180 degrees in the forward direction. In this case, the rotation status or whether there is a possibility that the halfway stop occurs is determined using the induced signal VRs generated in the detection resistor 501, so that the pulse control is executed.

By repeating the above-described operations, it is possible to prevent the halfway stop by accurately determining the rotation status of the stepping motor 102.

In another embodiment, the first reference threshold voltage Vcomp1 and the second reference threshold voltage Vcomp2 are not simultaneously generated, but are alternately generated. Therefore, since one comparator is used, the simpler configuration can be realized.

In each embodiment described above, the pulse width is made different to change the energy of each main driving pulse P1. However, the driving energy can be changed by shifting the pulse voltage.

The solar power generation means is used as an example of the generation means for charging the secondary battery 103. Instead, heating power generation means, manual winding power generation means, or automatic winding power generation means maybe used as the generation means for charging the secondary battery 103.

The voltage detection circuit 111 is provided to detect the voltage of the secondary battery 103. Instead, the voltage of the secondary battery 103 may be determined in accordance with the VRs pattern.

The calendar function is used as an example of the considerably changed load. Instead, various loads such as a load for executing a predetermined operation for a character provided in the display unit to notify a predetermined time may be used.

The electronic timepiece is used as an application example of the stepping motor. Instead, electronic apparatuses using a motor may be used.

The stepping motor control circuit according to the invention is applicable to various kinds of electronic apparatuses using the stepping motor.

The electronic timepiece according to the invention is applicable to an analog electronic timepiece with only the timepiece hands, an analog electronic wristwatch with a calendar function unit, various analog electronic timepieces with a calendar function unit, such as an analog electronic table clock with a calendar function unit, and various analog electronic timepieces.

What is claimed is:

1. A stepping motor control circuit comprising:
a secondary battery serving as a power source;
rotation detection means for detecting an induced signal generated by rotation of a rotor of a stepping motor and detecting a rotation status of the stepping motor depending on whether the induced signal exceeds a predetermined reference threshold voltage within a predetermined detection interval; and
control means for controlling driving of the stepping motor by one of a plurality of main driving pulses with mutually different energies or a correction driving pulse having an energy greater than that of each main driving pulse in accordance with the detection result of the rotation detection means,
wherein the detection interval is divided into a first interval immediately after the stepping motor is driven by the main driving pulse, a second interval later than the first interval, and a third interval later than the second interval, and
wherein in a case where a voltage of the secondary battery is lowered to be equal to or less than a predetermined voltage, the control means drives the stepping motor by the correction driving pulse when the control means drives the stepping motor by the main driving pulse and then the rotation detection means detects the induced signal exceeding a first reference threshold voltage in the first and second intervals and does not detect the induced signal exceeding a second reference threshold voltage lower than the first reference threshold voltage in the third interval.

2. The stepping motor control circuit according to claim 1, wherein in a case where the voltage of the secondary battery is lowered to be equal to or less than the predetermined voltage, the control means controls the driving of the stepping motor in a driving way different from that of the case where the voltage of the secondary battery exceeds the predetermined voltage.

3. The stepping motor control circuit according to claim 1, wherein the control means includes voltage detection means for detecting the voltage of the secondary battery.

4. The stepping motor control circuit according to claim 2, wherein the control means includes voltage detection means for detecting the voltage of the secondary battery.

5. The stepping motor control circuit according to claim 1, further comprising:
solar power generation means, heating power generation means, manual winding power generation means, or automatic winding power generation means as generation means for charging the secondary battery.

6. The stepping motor control circuit according to claim 2, further comprising:
solar power generation means, heating power generation means, manual winding power generation means, or automatic winding power generation means as generation means for charging the secondary battery.

7. The stepping motor control circuit according to claim 3, further comprising:
solar power generation means, heating power generation means, manual winding power generation means, or automatic winding power generation means as generation means for charging the secondary battery.

8. The stepping motor control circuit according to claim 4, further comprising:
solar power generation means, heating power generation means, manual winding power generation means, or automatic winding power generation means as generation means for charging the secondary battery.

9. The stepping motor control circuit according to claim 1, wherein the control means executes the driving by the correction driving pulse, and then increases the main driving pulse.

10. The stepping motor control circuit according to claim 2, wherein the control means executes the driving by the correction driving pulse, and then increases the main driving pulse.

11. The stepping motor control circuit according to claim 3, wherein the control means executes the driving by the correction driving pulse, and then increases the main driving pulse.

12. The stepping motor control circuit according to claim 4, wherein the control means executes the driving by the correction driving pulse, and then increases the main driving pulse.

13. The stepping motor control circuit according to claim 5, wherein the control means executes the driving by the correction driving pulse, and then increases the main driving pulse.

14. The stepping motor control circuit according to claim 6, wherein the control means executes the driving by the correction driving pulse, and then increases the main driving pulse.

15. The stepping motor control circuit according to claim 7, wherein the control means executes the driving by the correction driving pulse, and then increases the main driving pulse.

16. The stepping motor control circuit according to claim 1, wherein when the rotation detection means detects the induced signal exceeding the second reference threshold voltage in the third interval, the control means does not execute the driving by the correction driving pulse.

17. The stepping motor control circuit according to claim 16, wherein when the rotation detection means detects the induced signal exceeding the second reference threshold voltage in the third interval and the control means does not execute the driving by the correction driving pulse, the main driving pulse does not change.

18. The stepping motor control circuit according to claim 1,
wherein the rotation detection means includes:
a first comparator outputting a signal indicating whether the induced signal exceeds the first reference threshold voltage, when the induced signal and the first reference threshold voltage are input;
a second comparator outputting a signal indicating whether the induced signal exceeds the second reference threshold voltage, when the induced signal and the second reference threshold voltage are input; and
a selection circuit selectively outputting the signals output from the first and second comparators to the control means, and
wherein the selection circuit outputs the signal from the first comparator as a detection result of the first and second intervals and outputs the signal from the second comparator as a detection result of the third interval when the induced signal exceeding the first reference threshold voltage is detected in the first and second intervals.

19. The stepping motor control circuit according to claim 1,
wherein the rotation detection means includes:
a reference threshold voltage generation circuit selectively outputting the first and second reference threshold voltages; and
a comparator outputting, to the control means, a signal indicating whether the induced signal exceeds a reference threshold voltage from the reference threshold voltage generation circuit when the induced signal and the reference threshold voltage are input,
wherein the reference threshold voltage generation circuit inputs, to the comparator, the first reference threshold voltage as the reference threshold voltage of the first and second intervals and inputs, to the comparator, the second reference threshold voltage as the reference threshold voltage of the third interval when the induced signal exceeding the first reference threshold voltage is detected in the first and second intervals, and
wherein the comparator outputs a signal indicating whether the induced signal exceeds the first reference threshold voltage in the first and second intervals and outputs a signal indicating whether the induced signal exceeds the second reference threshold voltage in the third interval.

20. An analog electronic timepiece comprising:
a stepping motor rotatably driving timepiece hands; and
a stepping motor control circuit controlling the stepping motor,
wherein as this stepping motor control circuit, the stepping motor control circuit according to claim 1 is used.
